(19) United States
(12) Patent Application Publication
(10) Pub. No.: US 2017/0365964 A1
(43) Pub. Date: Dec. 21, 2017

(54) Type of Power Strip

(71) Applicant: Xiaobo Miao, Ruian (CN)

(72) Inventor: Xiaobo Miao, Ruian (CN)

(21) Appl. No.: 15/586,284

(22) Filed: May 4, 2017

(30) Foreign Application Priority Data
Jun. 18, 2016 (CN) 201610444830.2

(51) Int. Cl. H01R 27/02; H01R 13/502; H01R 13/447

(52) U.S. Cl. CPC H01R 27/02; H01R 13/447; H01R 13/502

(57) ABSTRACT

A new type of power strip comprises a power strip body composed of two or more socket units, the socket unit configured with a connecting structure and jacks, adjacent socket units fixed with each other through the connecting structure. Said jacks are three-way jacks and/or two-way jacks and/or USB jacks and/or switches. Said connecting structure compromises a socket and a plug configured on the socket unit, the socket configured with zero-line and fire-wire jack, the plug configured with corresponding zero-line and fire-wire jack-plug, zero-line jack and the zero-line jack-plug connected with zero line, and the fire-wire jack and the fire-wire jack-plug connected with the fire wire. The benefit of said invention: 1. simple structure and low manufacturing cost; 2. The invention simulates the principle of the train car, with socket units being used separately or stitched based on customer's own needs.

### FIELD OF THE INVENTION

The invention generally relates to a kind of electrical device, particularly a power strip.

### BACKGROUND ART

Existing power strips is typically larger, single structured, inconvenient to transport and carry along with.

### SUMMARY OF THE INVENTION

To address the deficiencies of the traditional power strips, bulky and inconvenient for transportation, the said invention provides a new type of power strip by connecting a number of socket units.

Technical solutions adopted by the invention to solve its technical problem:

Said new type of power strip comprises a power strip body composed of two or more socket units, the socket unit configured with a connecting structure and a jack, adjacent socket units fixed with each other through a connecting structure.

Said jacks are three-way jacks and/or two-way jacks and/or USB jacks and/or switches.

Said connecting structure compromises a socket and a plug configured on the socket unit, the socket configured with zero-line and fire-wire jack, the plug configured with corresponding zero-line and fire-wire jack-plug, zero-line jack and the zero-line jack-plug connected with zero line, and the fire-wire jack and the fire-wire jack-plug connected with the fire wire.

The socket unit configured with a connecting wire, a copper strip integrally stamped.

A dustproof baffle configured within the jacks, said dustproof baffle rotatably connected with respect to the jack, a return spring configured at the lower end of the dustproof baffle, with one end fixed with the jack, and the other end fixed with dust baffle. When the jack empty, the dustproof baffle seals the jack, when the jack is inserted, the dustproof baffle open.

Benefit of the said invention: 1. simple structure and low manufacturing cost; 2. The invention simulates the principle of the train car, with socket units being used separately or stitched based on customer's own needs.

### BRIEF DESCRIPTION OF THE DRAWINGS

FIG. 1 illustrates a schematic view of the connecting structure of the invention;

FIG. 2 illustrates a schematic view of the first embodiment of the invention;

FIG. 3 illustrates a schematic view of the second embodiment of the invention;

FIG. 4 illustrates a schematic view of the third embodiment of the invention;

### DETAILED DESCRIPTION OF SOME EMBODIMENTS

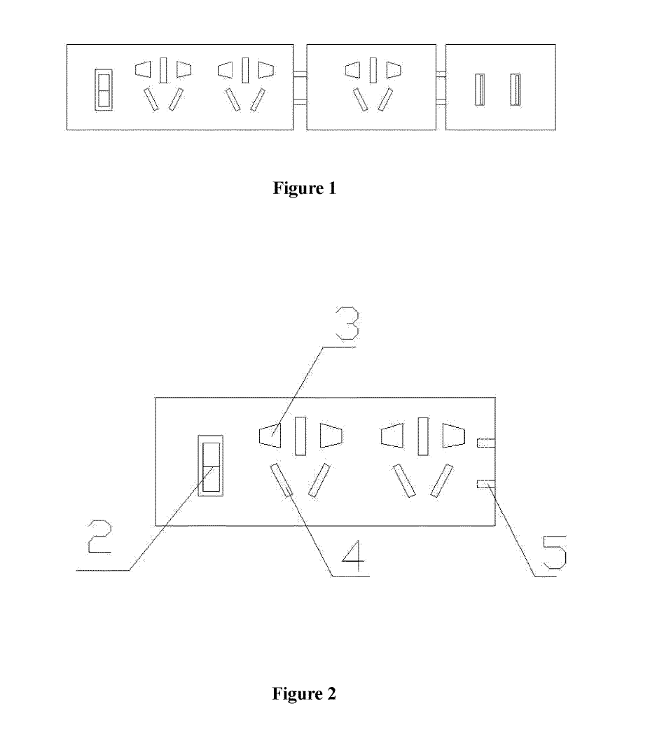

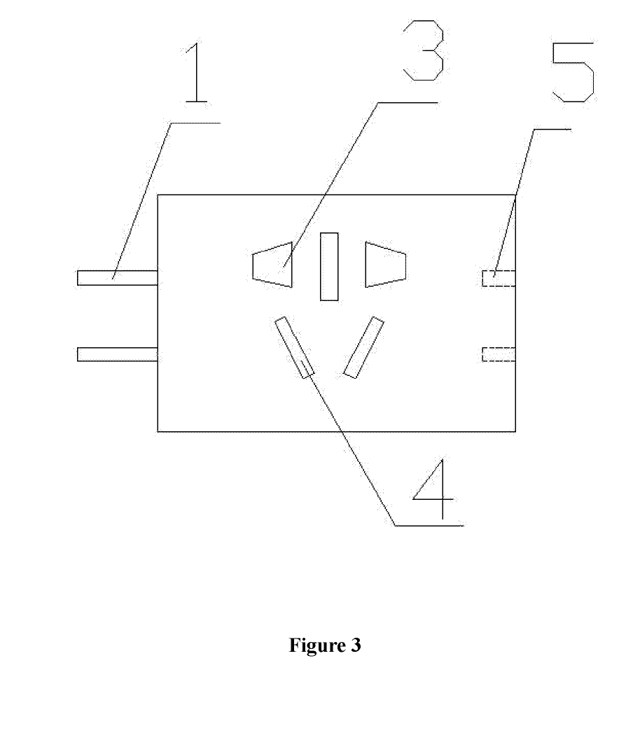

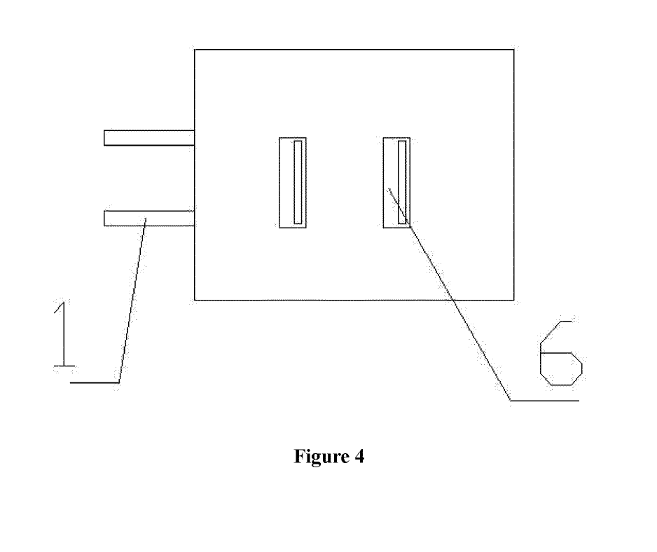

As illustrated in FIG. 1 to 4, a new type of new type of power strip comprises a power strip body composed of two or more socket units, the socket unit configured with a connecting structure and a jack, adjacent socket units fixed with each other through a connecting structure.

Said jacks are three-way jacks 4 and/or two-way jacks 3 and/or USB jacks 6 and/or switches 2.

Said connecting structure compromises a socket 5 and a plug 1 configured on the socket unit, the socket 5 configured with zero-line and fire-wire jack, the plug 1 configured with corresponding zero-line and fire-wire jack-plug, zero-line jack and the zero-line jack-plug connected with zero line, and the fire-wire jack and the fire-wire jack-plug connected with the fire wire.

The socket unit configured with a connecting wire, a copper strip integrally stamped.

A dustproof baffle configured within the jacks, said dustproof baffle rotatably connected with respect to the jack, a return spring configured at the lower end of the dustproof baffle, with one end fixed with the jack, and the other end fixed with dust baffle. When the jack empty, the dustproof baffle seals the jack, when the jack is inserted, the dustproof baffle open.

The design of the said power strip simulates the principle of the train car, with socket units being used separately or stitched based on customer's own needs, which changes the previous structure of a single, old-fashioned design style. Interior conductive copper strip is integrally stamped;

Integrated lightning-and-wave-proof surge design to provide security for the post-power design;

Integrated smart USB ports utilizing advanced foreign power management chip for convenient charging your mobile phone.

Benefit of the said invention: 1. simple structure and low manufacturing cost; 2. The invention simulates the principle of the train car, with socket units being used separately or stitched based on customer's own needs.

Embodiments of the invention are discussed above. However, those skilled in the art will readily appreciate that the embodiments given herein is for explanatory purposes, not to be construed as limiting the present invention. It should be appreciated that those skilled in the art will, in light of the teachings of the present invention, recognize numerous modifications and variations of the invention that are too numerous to be listed but that all fit within the scope of the invention.

1. A new type of power strip comprising a power strip body, wherein said power strip body is comprised of two or more socket units, said socket unit configured with a connecting structure and a jack, adjacent socket units fixed with each other through a connecting structure.

2. The new type of power strip as claimed in claim 1, wherein Said jacks are three-way jacks and/or two-way jacks and/or USB jacks and/or switches.

3. The new type of power strip as claimed in claim 1, wherein Said connecting structure compromises a socket and a plug configured on the socket unit, the socket configured with zero-line and fire-wire jack, the plug configured with corresponding zero-line and fire-wire jack-plug, zero-line jack and the zero-line jack-plug connected with zero line, and the fire-wire jack and the fire-wire jack-plug connected with the fire wire.

4. The new type of power strip as claimed in claim 1, wherein said socket unit configured with a connecting wire inside, said connecting wire is a copper strip integrally stamped.

5. The new type of power strip as claimed in claim 2, wherein a dustproof baffle configured within said jack, said dustproof baffle rotatably connected with respect to the jack, a return spring configured at the lower end of the dustproof baffle, with one end fixed with the jack, and the other end fixed with dust baffle. When the jack empty, the dustproof baffle seals the jack, when the jack is inserted, the dustproof baffle open.
